(19) United States
(12) Patent Application Publication
(10) Pub. No.: US 2012/0280828 A1
(43) Pub. Date: Nov. 8, 2012

(54) RFID-BASED ELECTRICITY METERING SYSTEM

(76) Inventor: Moon J. Kim, Wappingers Falls, NY (US)

(21) Appl. No.: 13/098,615

(22) Filed: May 2, 2011

(51) Int. Cl. G08C 15/06

(52) U.S. Cl. 340/870.02

(57) ABSTRACT

Embodiments of the present invention provide a radio frequency identification (RFID) based electricity metering system enabled to meter energy consumption of individual devices. Specifically, embodiments of this invention provide a set (a least one) of RFID sensor units, each RFID sensor unit comprising: an inductor affixed to the power line of an electronic device configured to produce an induced current using the power line of the electronic device through inductive coupling; a programmable gain amplifier (PGA) coupled to the inductor configured to provide gain or attenuation control on the induced current so that the induced current is properly scaled; an analog-to-digital converter (ADC) configured to convert the amplitude of the induced current to a digital value representing the energy consumption of the electronic device; a central processing unit (CPU) coupled to the ADC configured to receive the digital value from the ADC; a memory unit configured to store the digital value from the CPU; an antenna coupled to the CPU configured to transmit the digital value within a frequency band; and an RFID reader configured to receive the digital value transmitted by the RFID sensor unit.

### FIELD OF THE INVENTION

The present invention relates to energy metering systems. In particular, the present invention is directed to a system for an RFID-based electricity metering system enabled to meter energy consumption of individual devices.

### BACKGROUND OF THE INVENTION

An electricity meter is an electronic device that measures the amount of electric energy consumed by a residence, business, or an electrically powered device. As commercial use of electric energy spread in the late nineteenth century, the use of the electric energy meter became important in order to properly bill customers for the cost of energy. Electricity meters are typically calibrated in billing units, the most common one being the kilowatt hour. Periodic readings of electricity meters establish billing cycles and energy used during a cycle.

Conventional electricity meters invasively measure too sparingly (once a month) and feedback to the consumer (via a bill for energy consumed) can take still another month. It is difficult, if not impossible, for the consumer to determine how much energy is being consumed by each device. More advanced monitoring solutions are costly and typically do not include efficient energy consumption measurement for individual devices. Heretofore, several unsuccessful attempts have been made to address these shortcomings.

As is known, there are various electricity metering solutions that monitor energy use. Advanced Metering Infrastructure (AMI) are systems that measure, collect, and analyze energy usage. AMI involves two-way communications with “smart” meters and other energy management devices to provide automated utility metering. A smart meter is typically an electrical meter that records consumption of electric energy invasively at predefined time intervals. The collected information is communicated back to the utility at least once daily for monitoring and billing purposes. Smart meters may be part of a smart grid. A smart grid is a form of electricity network using digital technology in which electricity is delivered to consumers from suppliers using two-way digital communications to control appliances at consumer homes.

X10 is an industry standard for home automation in which compatible electronic devices communicate primarily using power line wiring for signaling and control. The system sends information through the existing home wiring from a transmitter. The system allows for communication with an individual device within the system. X10 actuators may be applied in the electrical devices allowing traditional operation using the switches on those devices, allowing a timer control, local control by means of an IR/RF control, or even remote control by telephone or Internet.

Device management can be realized using power outlet-based measurement and Zigbee (or similar) communication. ZigBee, based on IEEE 802.15.4, is a type of low-power communication technology. Zigbee is used in home networks, especially for the remote control of electric home devices. To introduce an electric device into the system, the user adds an interface circuit to the electric outlet to integrate the electric outlet into the network in order to enable remote power control and current measurement of the electric outlet.

U.S. Pat. No. 7,547,150 discloses an optical fiber cable housing with an integrated transducer and RFID element.

U.S. Pat. No. 7,468,669 discloses a method for identifying interconnect cables.

U.S. Patent Application 20100098425 discloses the use of a RFID overlay network with a fiber optic network for automating the discovery and configuration management of the physical fiber optic connections with a communications network.

U.S. Patent Application 20090040029 discloses a method for utilizing power storage devices to allow for non-peak demand electrical grid power to be stored and then resupplied back to the grid during peak demand times to reduce the peak demand power required from electrical generation facilities.

None of these references, however, teach a way to provide a noninvasive metering system in which a radio frequency identification (RFID) device passively monitors energy consumption of electronic devices.

### SUMMARY OF THE INVENTION

Embodiments of the present invention provide an RFID-based electricity metering system enabled to meter the energy consumption of individual devices. This is typically accomplished by: producing an induced current through inductive coupling using an inductor affixed to the power line of an electronic device; providing gain or attenuation control on the induced current so that the induced current is properly scaled; converting the amplitude of the induced current to a digital value representing the energy consumption of the electronic device; storing the digital value; and transmitting the digital value within a frequency band to an RFID reader.

The RFID-based electricity metering system is composed of two main parts: a set (at least one) of RF sensor units and the RFID reader. Two categories of RFID sensor units will be discussed. The first type of RFID, in fact a low frequency ID, sensor unit uses inductive coupling caused from the current flowing through the power line of an electronic device and an affixed power-coupling inductor to supply energy without the need of acquiring power from the RFID reader to perform its functions. The second type is a passive RFID sensor unit in that employs the electromagnetic energy transmitted by the RFID reader as power to perform its functions. Although both types of RFID sensor units are disclosed and discussed, the first type is the primary focus.

A first aspect of the present invention provides a radio frequency identification (RFID) based electricity metering system for metering the energy consumption of an electronic device, comprising: a set of RFID sensor units, each of the set of RFID sensor units comprising: an inductor affixed to (or embedded in) the power line of an electronic device configured to produce an induced current using the power line of the electronic device through inductive coupling; a programmable gain amplifier (PGA) coupled to the inductor configured to provide gain or attenuation control on the induced current so that the induced current is properly scaled; an analog-to-digital converter (ADC) configured to convert the amplitude of the induced current to a digital value representing the energy consumption of the electronic device; a central processing unit (CPU) coupled to the ADC configured to receive the digital value from the ADC; a memory unit configured to store the digital value from the CPU; an antenna coupled to the CPU configured to transmit the digital value within a frequency band; and a radio frequency identification (RFID) reader configured to receive the digital value transmitted by the RFID sensor unit.

A second aspect of the present invention provides a method for providing a radio frequency identification (RFID) based electricity metering system for metering the energy consumption of an electronic device, comprising: providing a set of RFID sensor units, each of the set of RFID sensor units comprising: an inductor affixed to the power line of an electronic device configured to produce an induced current using the power line of the electronic device through inductive coupling; a programmable gain amplifier (PGA) coupled to the inductor configured to provide gain or attenuation control on the induced current so that the induced current is properly scaled; an analog-to-digital converter (ADC) configured to convert the amplitude of the induced current to a digital value representing the energy consumption of the electronic device; a central processing unit (CPU) coupled to the ADC configured to receive the digital value from the ADC; a memory unit configured to store the digital value from the CPU; an antenna coupled to the CPU configured to transmit the digital value within a frequency band; and providing a radio frequency identification (RFID) reader configured to receive the digital value transmitted by the RFID sensor unit.

A third aspect of the present invention provides a method for metering the energy consumption of an electronic device, comprising: producing an induced current; providing gain or attenuation control on the induced current so that the induced current is properly scaled; converting the amplitude of the induced current to a digital value representing the energy consumption of the electronic device; storing the digital value; transmitting the digital value within at least one frequency band; and receiving the digital value at a radio frequency reader.

### BRIEF DESCRIPTION OF THE DRAWINGS

These and other features of this invention will be more readily understood from the following detailed description of the various aspects of the invention taken in conjunction with the accompanying drawings in which:

FIG. 1A is a diagram schematically illustrating a configuration of an RFID sensor unit and a power line wire.

FIG. 1B is a diagram schematically illustrating a more detailed view of an RFID sensor unit and a power line wire.

FIG. 2 is a diagram schematically illustrating a toroidal inductor and transformer.

FIG. 3 is a diagram schematically illustrating inductive coupling.

FIG. 4 is a diagram schematically illustrating the RFID sensor unit design.

FIG. 5 is a flow diagram illustrating a method for metering the energy consumption of an electronic device.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Exemplary embodiments will now be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms such as those defined in commonly used dictionaries should be interpreted as having a meaning that is consistent with their meaning in the context of the relevant art and the present disclosure, and will not be interpreted in an idealized or overly formal sense unless expressly so defined herein.

As indicated above, embodiments of the present invention provide a system for a radio frequency identification (RFID) based electricity metering system enabled to measure the energy consumption of individual devices. By integrating RFID into a meter reading system, power consumption data of customers can be fully collected. The disclosed RFID system measures the relative amplitude of the inductive current of an electronic device, digitizes the measurement information, stores the digitized measurement information, and transmits the digitized measurement information to the RFID reader. The noninvasive electricity metering system allows the consumer to see and react to the energy consumption of individual devices economically.

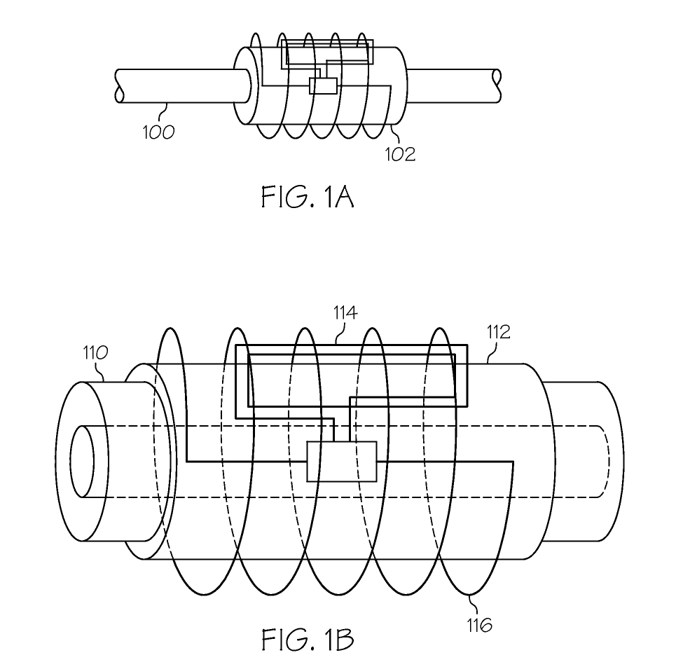

FIG. 1A is a diagram schematically illustrating a configuration of an RFID sensor unit and a power line wire. Radio frequency identification (RFID) sensor unit 102 is affixed to the power line wire 100 of an electronic device. An RFID sensor unit must be placed around the power line of each electronic device to be metered.

FIG. 1B is a diagram schematically illustrating a more detailed view of an RFID sensor unit and the power line wire of an electronic device. RFID 112 is placed around (e.g., taped to) power line wire 110 of an electronic device. RFID sensor units are placed around the power line of each electronic device to be measured to produce a wireless sensor network (WSN). RFID sensor unit 112 includes antenna 114 and inductor 116. Antenna 114 is used to transmit data to (and receive data from) any other RFID sensor unit within the WSN and the RFID reader. Power-coupling inductor 116 is used to assist in harvesting power to operate RFID sensor unit 112 through inductive coupling using the power line of the electronic device. The power is a harvested from the power line of the entity (i.e., electronic device) to be measured.

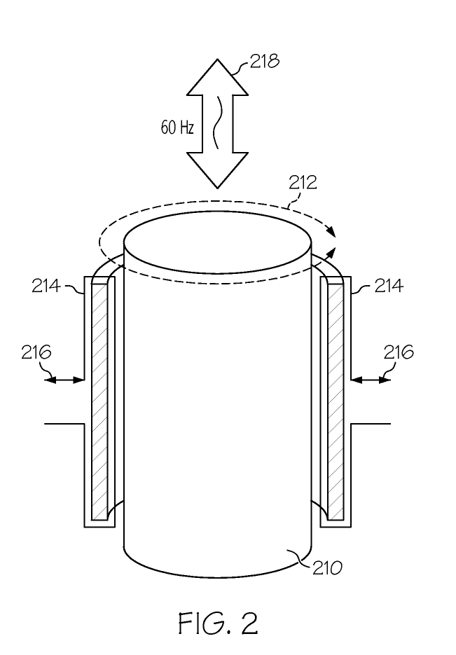

FIG. 2 is a diagram schematically illustrating a toroidal inductor and transformer. A conventional inductor is a three-dimensional solenoid or toroid type inductor. In general, solenoid type inductors include coils that are spaced apart from one another so that the inductor has a cylindrical shape, such as that associated with a solenoid. Toroidal inductors have a circular magnetic core with coils wrapped around it. FIG. 2 depicts a toroidal inductor. Current 218 passes through wire 210. Coil 214 is wrapped around wire 210. The coil loops help to create strong magnet field 212 inside coil 214. Wire 210 and inductor produce induced current 216.

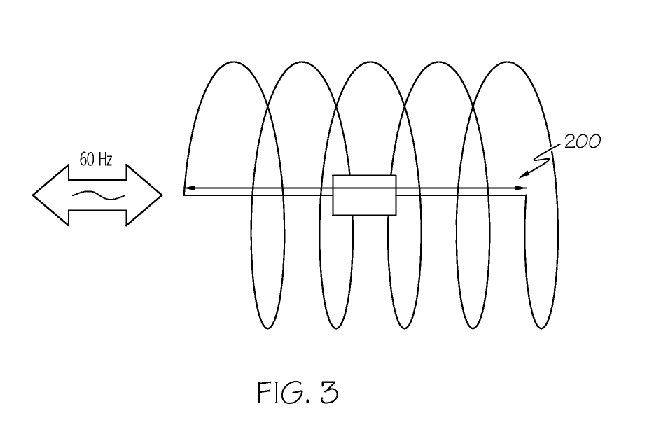

FIG. 3 is a diagram schematically illustrating inductive coupling. When a wire carries an electrical current, it produces a magnetic field. An inductor is a passive electrical component that can store energy in a magnetic field created by the electric current passing through it. The power line and the inductor form a transformer, so inductive coupling allows energy transmission between them. An RFID sensor unit uses induced current 200 caused from the current flowing through the power line of an electronic device and an affixed power-coupling inductor to supply energy for the RFID sensor unit to operate.

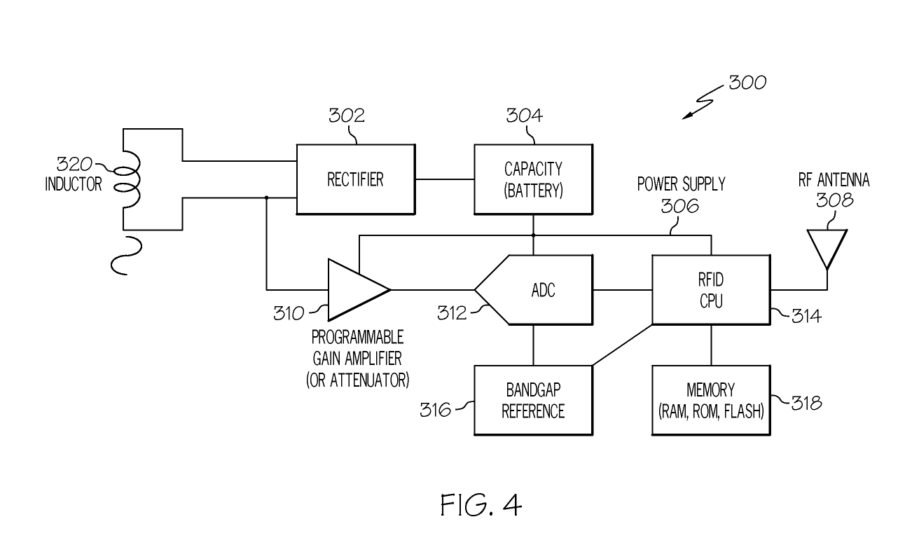

FIG. 4 is a diagram schematically illustrating the RFID sensor unit design. RFID sensor unit includes inductor 320, rectifier 302, capacitor 304, power supply 306, programmable gain amplifier (PGA) (or attenuator) 310, analog-to-digital converter (ADC) 312, bandgap refererence 316, RFID central processing unit (CPU) 314, memory 318, and antenna 308. Each component will be discussed in detail below.

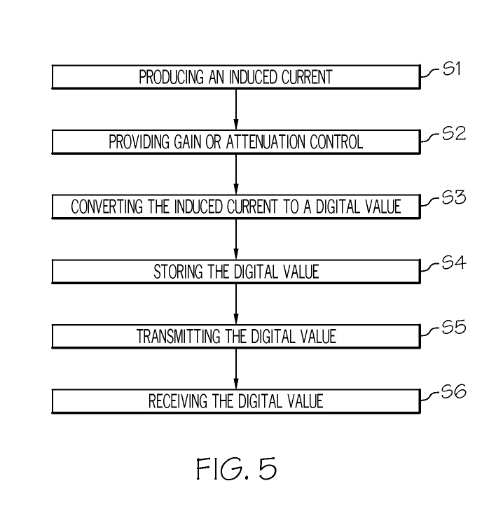

FIG. 5 is a flow diagram illustrating a method for metering the energy consumption of an electronic device. The first step is producing an induced current (S1) between the power line of the electronic device and an inductor. The second step is providing gain or attenuation control on the induced current so that the induced current is properly scaled (S2). The third step is converting the amplitude of the induced current to a digital value representing the energy consumption of the electronic device (S3). The fourth step is storing the digital value representing the energy consumption of the electronic device (S4). The fifth step is transmitting the digital value within a frequency band (S5). Finally, the sixth step is receiving the digital value at a radio frequency reader (S6).

Referring back to FIG. 3, the RFID system utilizes the induced coil voltage for operation. This induced AC voltage is rectified to provide a voltage source for the device. The first step in getting any powered system to work is getting it powered up and running. Rectification is a passive process to power up the RFID sensor unit by taking the alternating current (AC) of the induced current and converting it into a direct current (DC). Rectifier 302 is the component that performs this duty. Rectifier 302 converts RF power into DC energy as stored charge in capacitor 304. RFID CPU 314 controls and checks rectifier 302 in order to optimize the power efficiency of the system. Capacitor 304 is the power supply for the system. RFID CPU 314 controls and checks capacitor 304 to determine how much power is available for operations, such as data transmission.

Alternatively, the RFID may be passively powered by the RFID reader. In this case, the RFID sensor unit uses the electromagnetic energy transmitted by an RFID reader to power its functions. When radio waves from the RFID reader are encountered by the RFID unit, the coiled antenna forms a magnetic field. The RFID sensor unit draws power from it, energizing the circuits in the unit.

The input signal must be converted to a digital value that can be measured, stored, and transmitted. Analog-to-digital converter (ADC) 312 converts the input voltage of the induced current to a digital word. RFID central processing unit (CPU) 314 controls ADC 312. ADC 312 provides an output that digitally represents the input voltage or current level. Systems with a wide dynamic range need a method of adjusting the input level to ADC 312. The incoming voltage may be too high or too low for ADC 312 to measure. PGA 310 provides gain/attenuation control to ensure the incoming signal is properly scaled. RFID CPU 314 controls PGA 310.

Voltage reference circuits are widely used in data converters, such as ADC 312. Voltage references are a key building block in data conversion systems. The reference voltage acts as a very precise analog ‘meter stick’ against which the incoming analog signal is compared in ADC 312. As such, a stable system reference is required for accurate and repeatable data conversion. Bandgap reference module 316 provides the reference voltage for ADC 312 that is free from temperature effect and ripple voltage perturbation. RFID CPU 314 periodically checks the bandgap reference operation to ensure ADC 312 always has a valid reference value.

RFID CPU 314 has functions and responsibilities in addition to those discussed previously. RFID CPU 314 receives the value representing the induced current amplitude outputted by ADC 312, stores the measurement information in memory unit 318, and causes antenna 308 to transmit the measurement data over a radio frequency wave. Memory unit 318 is coupled to RFID CPU 314. RFID CPU 314 controls internal memory and nonvolatile memory to keep the track of all necessary information discussed herein. Memory unit 318 includes random access memory (RAM), ROM, and flash memory for data processing, firmware, and non-volatile rewriteable storage. RAM provides space for data being accessed by RFID CPU 314. ROM is used to distribute firmware. Firmware denotes the fixed programs and/or data structures used to control the various components of the RFID sensor unit.

Measurement values are stored in non-volatile rewriteable storage. Measurement values may be stored with a timestamp in memory unit 318, since it might be necessary to flush out data after a predefined amount of time has elapsed. Also, situations may arise when it is necessary to relay the data to other RFID sensor units within the WSN in order to get it closer to its final destination, which is the data collection point (i.e., the RFID reader).

Transmission of measurement data may take place using one of two methods: through an RF channel or through the power line of the electronic device. Three separate processes are possible when transmitting data through an RF channel. First, the RFID transmits an active event to an RFID reader. The RFID uses the power harvested from the power line to transmit the data to the reader. Power off event transmission might be possible if the battery is big enough. Second, the RFID is passively powered by an RFID reader in cases when there is no current in the power line. The RFID performs the measurements and returns the result to the reader. Third, the RFID is activated by power line, but receives a request from the RFID reader. The RFID performs the measurements and transmits the measurements to the reader.

The second transmission method involves transmitting the measurement data through the power line. The RFID transmits data by modulating the power line solenoid or toroid. The direct current flowing in the circuit is made to carry the signal to the receiver by forcing high-frequency inductive coupling to the power line. The signal is captured by an RFID reader connected to power line when an obstruction blocks the RF transmission from the RFID.

RFID CPU 314 controls all the internal and external signal transactions between components, the RFID reader, and other RFID sensor units within the wireless sensor network (WSN). RFID CPU 314 also maintains communication protocols with the RFID reader or other WSN agents.

For the system to be useful to a consumer, the energy consumption measurements must be accurate. The quality of measurements can be improved by measurement calibration. Controlled and selective device switching and power consumption measurement allows for calibration of RFID measurements in order to get closer to real current in the power line.

In one embodiment of the present invention, a single-band RFID is used. The RFID powers up and transmits through the single band. Alternatively, a dual-band RFID for cross-over communication is used. Dual band refers to an electronic device's ability to function on two different frequency bands. In this embodiment, the dual-band RFID powers up with the first frequency band and transmits through the second frequency band.

While the exemplary embodiments have been shown and described, it will be understood by those skilled in the art that various changes in form and details may be made thereto without departing from the spirit and scope of this disclosure as defined by the appended claims. In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A radio frequency identification (RFID) based electricity metering system for metering the energy consumption of an electronic device, comprising:
a set of RFID sensor units, each of the set of RFID sensor units comprising:
an inductor affixed to the power line of an electronic device configured to produce an induced current using the power line of the electronic device through inductive coupling;
a programmable gain amplifier (PGA) coupled to the inductor configured to provide gain or attenuation control on the induced current so that the induced current is properly scaled;
an analog-to-digital converter (ADC) configured to convert the amplitude of the induced current to a digital value representing the energy consumption of the electronic device;
a central processing unit (CPU) coupled to the ADC configured to receive the digital value from the ADC;
a memory unit configured to store the digital value from the CPU;
an antenna coupled to the CPU configured to transmit the digital value within a frequency band; and
an RFID reader configured to receive the digital value transmitted by the RFID sensor unit.

2. The metering system of claim 1, the RFID sensor unit further comprising:
a rectifier coupled to the inductor configured to receive the alternating current (AC) of the induced current and convert it into a direct current (DC); and
a capacitor coupled to the rectifier configured to store the DC as a charge.

3. The metering system of claim 2, the RFID sensor unit further comprising a bandgap reference module coupled to the ADC configured to provide a reference voltage for the ADC.

4. The metering system of claim 1, wherein the CPU is powered from the capacitor.

5. The metering system of claim 1, wherein the CPU is passively powered using inductive coupling with the RFID reader.

6. The metering system of claim 1, wherein the data value is transmitted through the power line to an RF reader by forcing high-frequency inductive coupling to the power line.

7. The metering system of claim 1, wherein the RFID sensor unit is configured to receive data from the RFID reader.

8. The metering system of claim 7, wherein the data value is transmitted to the RFID reader in response to a request from the reader.

9. The metering system of claim 1, wherein the metering system is configured to function on a single frequency band.

10. The metering system of claim 1, wherein the metering system is configured to function on dual frequency bands.

11. The metering system of claim 3, wherein the CPU further configured to control one or more of the following: the rectifier, the capacitor, the PGA, the ADC, the bandgap reference module, the memory unit, and the antenna.

12. The metering system of claim 1, wherein the CPU is further configured to maintain communication protocols with the RFID reader and any other RFID sensor units.

13. The metering system of claim 1, wherein the RFID reader is configured to transmit data to each of the set of RFID sensor units.

14. A method for providing a radio frequency identification (RFID) based electricity metering system for metering the energy consumption of an electronic device, comprising:
providing a set of RFID sensor units, each of the set of RFID sensor units comprising:
an inductor affixed to the power line of an electronic device configured to produce an induced current using the power line of the electronic device through inductive coupling;
a programmable gain amplifier (PGA) coupled to the inductor configured to provide gain or attenuation control on the induced current so that the induced current is properly scaled;
an analog-to-digital converter (ADC) configured to convert the amplitude of the induced current to a digital value representing the energy consumption of the electronic device;
a central processing unit (CPU) coupled to the ADC configured to receive the digital value from the ADC;
a memory unit configured to store the digital value from the CPU;
an antenna coupled to the CPU configured to transmit the digital value within a frequency band; and
providing an RFID reader configured to receive the digital value transmitted by the RFID sensor unit.

15. The metering system of claim 14, the RFID sensor unit further comprising:
a rectifier coupled to the inductor configured to receive the alternating current (AC) of the induced current and convert it into a direct current (DC); and
a capacitor coupled to the rectifier configured to store the DC as a charge.

16. The metering system of claim 15, the RFID sensor unit further comprising a bandgap reference module coupled to the ADC configured to provide a reference voltage for the ADC.

17. The metering system of claim 14, wherein the CPU is powered from the capacitor.

18. The metering system of claim 14, wherein the CPU is passively powered using inductive coupling with the RFID reader.

19. The metering system of claim 14, wherein the data value is transmitted through the power line to an RF reader by forcing high-frequency inductive coupling to the power line.

20. The metering system of claim 14, wherein the RFID sensor unit is configured to receive data from the RFID reader.

21. The metering system of claim 20, wherein the data value is transmitted to the RFID reader in response to a request from the reader.

22. The metering system of claim 14, wherein the metering system is configured to function on a single frequency band.

23. The metering system of claim 14, wherein the metering system is configured to function on dual frequency bands.

24. The metering system of claim 16, wherein the CPU is further configured to control one or more of the following: the rectifier, the capacitor, the PGA, the ADC, the bandgap reference module, the memory unit, and the antenna.

25. The metering system of claim 14, wherein the CPU is further configured to maintain communication protocols with the RFID reader and any other RFID sensor units.

26. The metering system of claim 14, wherein the RFID reader is configured to transmit data to each of the set of RFID sensor units.
